(19) United States
(12) Patent Application Publication
(10) Pub. No.: US 2006/0153193 A1
(43) Pub. Date: Jul. 13, 2006

(54) Network routing control method and apparatus

(76) Inventors: In-Ho Kim, Suwon-si (KR); Byung-Chang Kang, Yongin-si (KR); Yong-Seok Park, Seongnam-si (KR)

Correspondence Address: Robert E. Bushnell, Suite 300, 1522 K Street, N.W., Washington, DC, 20005, US

(21) Appl. No.: 11/319,238

(22) Filed: Dec. 29, 2005

(30) Foreign Application Priority Data
Jan. 7, 2005 (KR) 2005-1874

(51) Int. Cl. H04L 12/56

(52) U.S. Cl. 370/392; 370/238

(57) ABSTRACT

A network routing control method includes: setting best and secondary route information while receiving/transmitting a routing protocol control message with adjacent routers; setting a table having best and secondary next hop entries using the best and secondary route information; extracting a destination IP address from the best and secondary route information to set a forwarding table; and when a failure occurs in a network which is set as the best next hop entry according to the best route information, setting the secondary next hop entry as an output interface according to the secondary route information to forward a corresponding packet.

### CLAIM OF PRIORITY

This application makes reference to, incorporates the same herein, and claims all benefits accruing under 35 U.S.C. §119 from an application for NETWORK ROUTING CONTROLLING METHOD AND APPARATUS earlier filed in the Korean Intellectual Property Office on 7 Jan. 2005 and there duly assigned Serial No. 2005-1874.

### BACKGROUND OF THE INVENTION

1. Field of the Invention

The present invention relates to a network routing control method, and more particularly, to a network routing control method employed by a router which rapidly detects network failure during routing transmission of an Internet protocol (IP) packet to rapidly switch the IP packet to an alternative interface, thereby reducing loss of the IP packet.

2. Description of the Related Art

Due to the rapid increase in Internet users, diversification of provided services, and expansion of application fields such as voice over Internet protocol (VoIP), Internet traffic is increasing exponentially. In order to transmit an IP packet to a corresponding destination in the shortest possible time over the Internet, in the case of a high-speed gigabit or terabit router, it is necessary to find a path to the destination of the IP packet without any delay and forward the IP packet through the path. In order to find a destination route of the IP packet which is transmitted through a physical input interface of each router, functions for maintaining a shortest path table (i.e., routing or forwarding table), for efficiently managing the routing table, and for reducing a retrieving time, are necessary.

The following illustrates connection between routers over the Internet.

The routers include forwarding engines, respectively, and are connected to each other through the forwarding engines. The routers are devices which connect separate networks which use the same transmission protocol. The routers connect the network layers and determine a routing node in its network or a different network according to a forwarding table (route allocation table). The routers select the most efficient route among various routes to transmit the IP packet to the destination address.

The forwarding engines in the routers determine a next hop with reference to the destination address of the IP packet while transmitting the IP packet to the router corresponding to the next hop.

The condition of the forwarding engines is as follows. First, prefix lengths 16, 24, and 32 are set to levels 1, 2 and 3, respectively, a pattern bit is set to a 2-bit for minimizing use of bits, information of the next hop is represented by one byte, and information of the next hop may be an output port number or the interface number of the packet. Also, the address is designated by only a 2-byte offset value, a segment value is appropriately designated, and if it is assumed that “nptr” is a pointer where the next hop or information of the next hop is located, “nptr=(segment shift 16)+offset” is a value representing the physical location.

The following illustrates a conventional router. The router includes a routing setter, a forwarding manager, a forwarding table, a next hop table, and a forwarding portion.

The routing setter sets the best route which is the lowest in cost by routing protocol control message routing information protocol (RIP), open shortest path first (OSPF), bolder gateway protocol (BGP), or static which is received/transmitted from/to adjacent routers. The routing setter provides the forwarding manager with the set best route information. Here, the best routing information may include IP address information, netmask information, next hop information which represents an output port of an input IP packet, and so on.

The forwarding manager extracts the next hop information from the best route information provided from the routing setter to set the next hop table. The forwarding manager extracts the destination IP address from the best route information from the routing setter to set the forwarding table.

The forwarding portion routes or forwards the input IP packet using information stored in the forwarding table and the next hop table. In more detail, when the IP packet is received, the forwarding portion detects the destination IP address corresponding to the destination address of the IP packet with reference to the forwarding table, and detects physical address information of the corresponding next hop table. Then, the forwarding portion adds a header to the IP packet using the next hop entry value corresponding to the physical address value which corresponds to the physical address information in the next hop table and then forwards the IP packet to a corresponding router.

However, a corresponding output port may undergo a failure such as a down link due to a network failure while forwarding the IP packet using the best route information selected by the routing setter. At this time, the routing setter exchanges control information such as a heart bit with the adjacent routers to set the best route information again. Thus, until the best route is reset after the network failure, all IP packets routed to the corresponding output port according to the already-set best route are lost. For example, while the best route is reset, the IP packets are lost for 40 seconds in the case of the OSPF and for 180 seconds in the case of the RIP.

### SUMMARY OF THE INVENTION

It is, therefore, an objective of the present invention to provide a network routing control method and apparatus which can reduce loss of IP packets which results from a network failure of a corresponding interface.

It is another objective to provide a network routing control method and apparatus which can reduce loss of IP packets which may occur until a best route is reset in case where a corresponding output portion fails due to a network failure while the IP packets are forwarded through an already-set routing path.

It is yet another objective to provide a network routing control method and apparatus which can reduce loss of IP packets by forwarding the IP packets through an alternative routing path until a best route is reset in a case where a corresponding output portion fails due to a network failure while the IP packets are forwarded through an already-set routing path.

It is still another objective of the present invention to provide a network routing control technique and apparatus that is easy to implement and cost effective while performing more efficiently.

According to an aspect of the present invention, there is provided a network routing control method including: setting best and secondary route information while receiving/transmitting a routing protocol control message with adjacent routers; setting a table having best and secondary next hop entries using the best and secondary route information; extracting a destination IP address from the best and secondary route information to set a forwarding table; and when a failure occurs in a network which is set as the best next hop entry according to the best route information, setting the secondary next hop entry as an output interface according to the secondary route information and forwarding a corresponding packet.

According to another aspect of the present invention, there is provided a network routing control method including: setting best and secondary route information while receiving/transmitting a routing protocol control message with adjacent routers; setting best and secondary next hop tables using the best and secondary route information; registering an active output interface according to the best and secondary next hop tables in a survival port list table; storing an index number of the best and secondary next hop tables in a next hop list table; storing a destination IP address of the best and secondary route information in a forwarding table and setting a physical address of the best next hop entry of the best next hop table; and when a failure occurs in a network which is set as the best next hop entry, setting the secondary next hop entry corresponding to the index number as an output interface and forwarding a corresponding packet.

According to yet another aspect of the present invention, there is provided a network routing control apparatus including: a routing setter for setting best and secondary route information while receiving/transmitting a routing protocol control message with adjacent routers; a forwarding manager for setting a table having best and secondary next hop entries using the best and secondary route information and extracting a destination IP address from the best and secondary route information to set a forwarding table; and a forwarding portion for setting the secondary next hop entry as an output interface according to the secondary route information and forwarding a corresponding packet when a failure occurs in a network which is set as the best next hop entry according to the best route information.

According to still another aspect of the present invention, there is provided a network routing control apparatus including: a routing setter for setting best and secondary route information while receiving/transmitting a routing protocol control message with adjacent routers; a forwarding manager for setting best and secondary next hop tables using the best and secondary route information, registering an active output interface according the best and secondary next hop tables in a survival port list table, storing an index number of the best and secondary next hop tables in a next hop list table, storing a destination IP address of the best and secondary route information in a forwarding table, and setting a physical address of a corresponding best next hop entry of the best next hop table; and a forwarding portion for setting a secondary next hop entry corresponding to the index number as an output interface to forward the corresponding packet when a failure occurs in a network which is set as the best next hop entry.

Preferably, both the best and the secondary routes are set, so that the forwarding table is set using the information. When a network failure occurs in the corresponding interface, the network failure can be detected. Thus, until the best route is reset by the routing setter and the forwarding table is reset, the IP packets are forwarded through the secondary route which is already set. Accordingly, loss of IP packets is significantly reduced, leading to high network reliability.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram illustrating connection between routers over the Internet;

FIG. 2 is a block diagram illustrating a conventional router;

FIG. 3 is a block diagram illustrating a router according to the present invention;

FIG. 4 shows a best next hop table and a secondary next hop table of the router of FIG. 3; and

FIGS. 5A and 5B are flowcharts of a network routing control method according to the present invention.

### DETAILED DESCRIPTION OF THE PREFERRED EMBODIMENTS

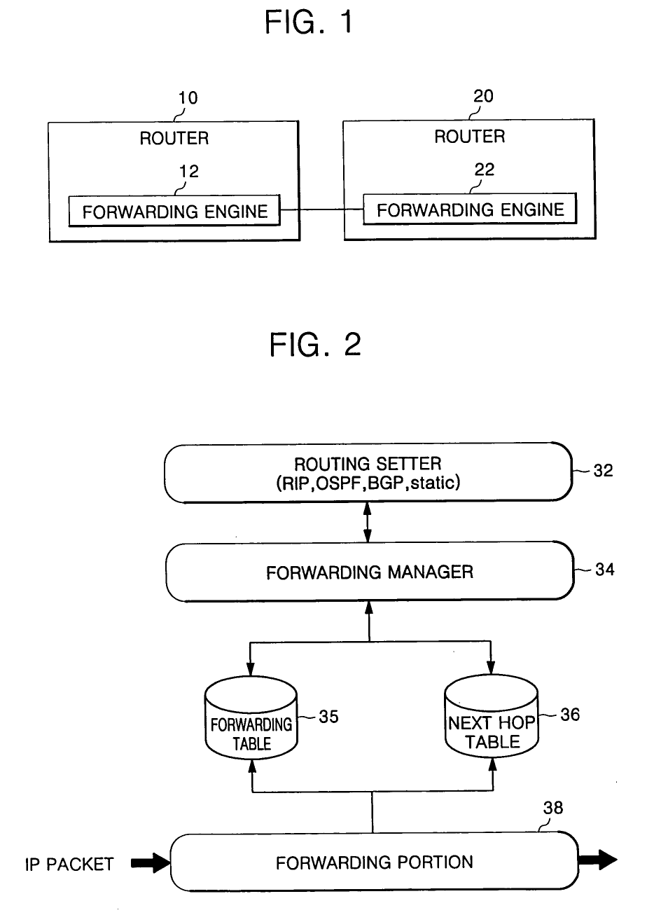

Turning now to the drawings, FIG. 1 is a block diagram illustrating connection between routers over the Internet.

The routers 10 and 20 include forwarding engines 12 and 22, respectively, and are connected to each other through the forwarding engines 12 and 22. The routers 10 and 20 are devices which connect separate networks which use the same transmission protocol. The routers 10 and 20 connect the network layers and determine a routing node in its network or a different network according to a forwarding table (route allocation table). The routers 10 and 20 select the most efficient route among various routes to transmit the IP packet to the destination address.

The forwarding engines 12 and 22 in the routers 10 and 20 determine a next hop with reference to the destination address of the IP packet while transmitting the IP packet to the router corresponding to the next hop.

The condition of the forwarding engines 12 and 22 is as follows. First, prefix lengths 16, 24, and 32 are set to levels 1, 2 and 3, respectively, a pattern bit is set to a 2-bit for minimizing use of bits, information of the next hop is represented by one byte, and information of the next hop may be an output port number or the interface number of the packet. Also, the address is designated by only a 2-byte offset value, a segment value is appropriately designated, and if it is assumed that “nptr” is a pointer where the next hop or information of the next hop is located, “nptr=(segment shift 16)+offset” is a value representing the physical location.

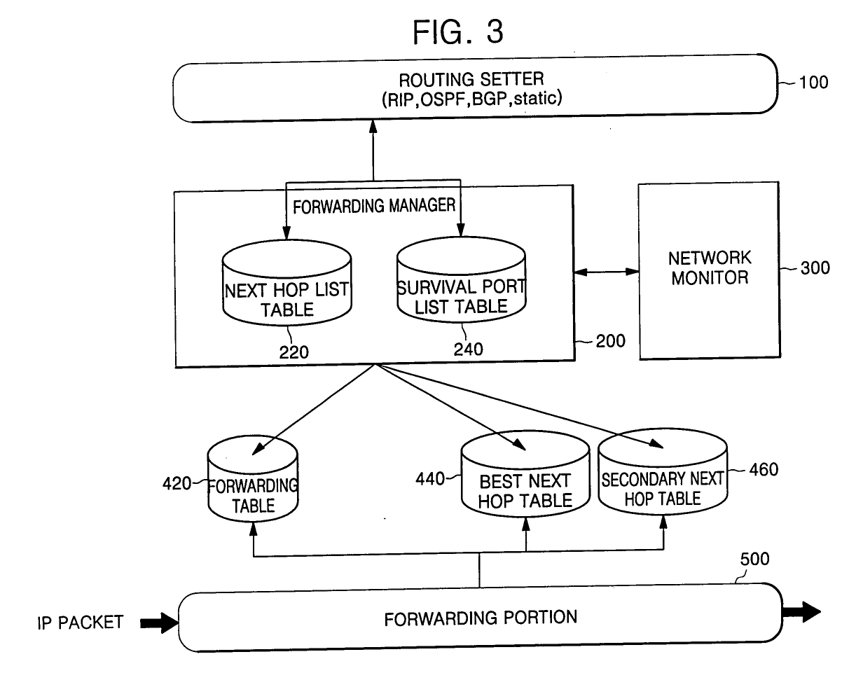

FIG. 2 is a block diagram illustrating a conventional router. As shown in FIG. 2, the router includes a routing setter 32, a forwarding manager 34, a forwarding table 35, a next hop table 36, and a forwarding portion 38.

The routing setter 32 sets the best route which is the lowest in cost by routing protocol control message routing information protocol (RIP), open shortest path first (OSPF), bolder gateway protocol (BGP), or static which is received/transmitted from/to adjacent routers. The routing setter 32 provides the forwarding manager 34 with the set best route information. Here, the best routing information may include IP address information, netmask information, next hop information which represents an output port of an input IP packet, and so on.

The forwarding manager 34 extracts the next hop information from the best route information provided from the routing setter 32 to set the next hop table 36. The forwarding manager 34 extracts the destination IP address from the best route information from the routing setter 32 to set the forwarding table 35.

The forwarding portion 38 routes or forwards the input IP packet using information stored in the forwarding table 35 and the next hop table 36. In more detail, when the IP packet is received, the forwarding portion 38 detects the destination IP address corresponding to the destination address of the IP packet with reference to the forwarding table 36, and detects physical address information of the corresponding next hop table. Then, the forwarding portion 38 adds a header to the IP packet using the next hop entry value corresponding to the physical address value which corresponds to the physical address information in the next hop table 36 and then forwards the IP packet to a corresponding router.

However, a corresponding output port may undergo a failure such as a down link due to a network failure while forwarding the IP packet using the best route information selected by the routing setter 32. At this time, the routing setter 32 exchanges control information such as a heart bit with the adjacent routers to set the best route information again. Thus, until the best route is reset after the network failure, all IP packets routed to the corresponding output port according to the already-set best route are lost. For example, while the best route is reset, the IP packets are lost for 40 seconds in the case of the OSPF and for 180 seconds in the case of the RIP.

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

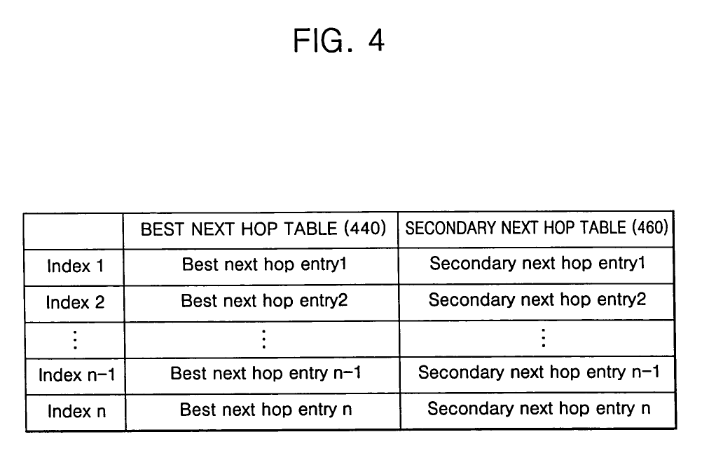

FIG. 3 is a block diagram illustrating a router for high-speed transmission IP packet protection according to the present invention.

As shown in FIG. 3, the router includes a routing setter 100, a forwarding manager 200, a network monitor 300, a forwarding table 420, a best next hop table 440, a secondary next hop table 460, and a forwarding portion 500.

The routing setter 100 sets a best route which is the lowest in cost and a secondary route which is the next lowest in cost by routing protocol control message RIP, OSPF, BGP, or static which is received/transmitted from/to the adjacent routers. The routing setter 100 provides the forwarding manager 200 with the set best route information. Here, the best route information and the secondary route information may each include IP address information, netmask information, next hop information which represents an output port of an input IP packet, and so on.

The forwarding manager 200 manages a list of output interfaces which are in an active state among output ports of the router in a network system connected to the present router. Here, the forwarding manager 200 manages the active output interface list using a survival port list table 240. The survival port list table 240 maintains the active output interface list information when an interface is produced in the router.

The forwarding manager 200 checks whether output interfaces for outputting a corresponding IP packet according to routes set by the best route information and the secondary route information provided from the routing setter 100 are in an active state, using the survival port list table 240. If the output ports are in an active state, the forwarding manager 200 extracts next hop information from the best route information to set the best next hop table 440, and extracts next hop information from the secondary route information to set the secondary next hop table 460.

The forwarding manager 200 extracts destination IP address information from the best route information provided from the routing setter 100 to set the forwarding table 420. Preferably, the forwarding manager 200 extracts a marking value of the destination IP address 11 and the netmask from the best route information provided from the routing setter 100 to set the forwarding table 420. The forwarding manager 200 sets the marking value as a physical address value of a corresponding entry of the best next hop table 440. Also, the forwarding manager 200 stores a list of indexes of the best and secondary next hop tables 440 and 460 for corresponding interface numbers in the next hop list table 220.

The forwarding portion 500 retrieves the destination IP address with reference to the forwarding table 420 and the physical address of the best next hop table 440 which is already set when the IP packet is received. The forwarding portion 500 retrieves a best next route entry, from the best next hop table 440, corresponding to the physical address retrieved from the forwarding table 420. Thus, the forwarding portion 500 adds a header to the IP packet using the retrieved next hop entry value and forwards it to a corresponding router.

The network monitor 300 detects whether a network set by the best route information fails and then outputs the detection result to the forwarding manager 200.

When a network failure message is received, the forwarding manager 200 deletes a corresponding output interface having the network failure from the survival port list table 240. This is done in order for the forwarding manager 200 to prevent the routing setter 100 from further changing the next hop table for the output interface having the network failure.

The forwarding manager 200 detects the next hop index which is already set from the next hop list table 220 using the input network failure message. Also, the forwarding manager 200 sets a physical address of a corresponding entry of the secondary next hop table 460 in the forwarding table 420.

The forwarding portion 500 retrieves the destination IP address of the input IP packet from the forwarding table 420, and retrieves the physical address of the secondary next hop table 460 which is already set for the retrieved destination IP address. The forwarding portion 500 retrieves a secondary next route entry, from the secondary next hop table 460, corresponding to the physical address retrieved from the forwarding table 420. Thus, the forwarding portion 500 adds a header to the IP packet using the retrieved secondary next hop entry value and forwards it to the corresponding router.

As described above, the routing setter 100 sets the secondary route as well as the best route, and the forwarding table is set using the information. When a network failure occurs in the corresponding interface, the network failure can be detected, and until the best route is reset by the routing setter 100 and the forwarding table is reset, the IP packets are forwarded through the secondary route which is already set, whereby loss of the IP packets is significantly reduced, leading to high network reliability.

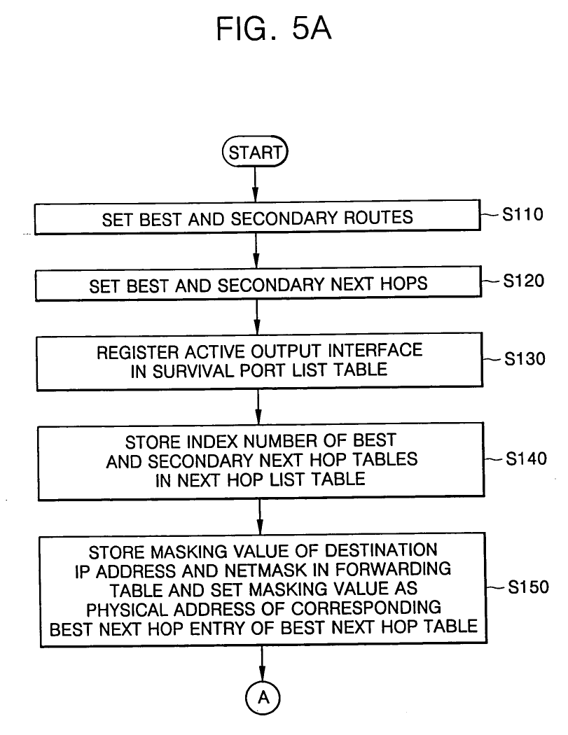

FIG. 4 shows the best next hop table 440 and the secondary next hop table 460 of FIG. 3.

As shown in FIG. 4, each entry of the best and secondary next hop tables 440 and 460 is set by one index number with the same physical address. That is, the forwarding portion 500 determines the next hop entry with reference to either of the best and secondary next hop tables 440 and 460 when the physical address of the next hop table is retrieved from the forwarding table 420. For example, the best next hop table 440 is referred for forwarding the IP packet using the best route information. In order to forward the IP packet using the secondary route information when a network failure occurs, it is required to determine as the next hop entry an entry having the same physical address as the corresponding entry of the best next hop table 440 with reference to the secondary next hop table 460.

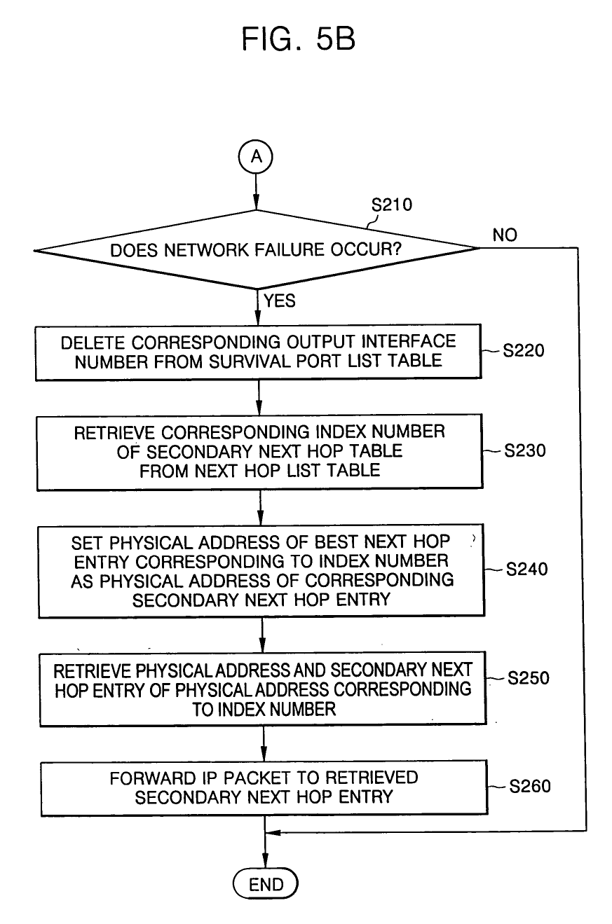

FIGS. 5A and 5B are flowcharts of a network routing control method according to the present invention.

Referring to FIG. 5A, the routing setter 100 sets the best route which is the lowest in cost and the secondary route which is the next lowest in cost using the routing protocol control message RIP, OSPF, BGP, or static which is received/transmitted (received or transmitted) from/to (from or to) adjacent routers (S110).

The forwarding manager 200 sets the best and secondary next hop tables using the best and secondary route information set by the routing setter 100 (S120). Here, the forwarding manager 200 registers the active output interface in the survival port list table 240 (S130).

The forwarding manager 200 stores the index numbers of the best and secondary next hop tables 440 and 460 in the next hop list table 220 (S140). The forwarding manager 200 stores masking values of the destination IP address and the netmask in the forwarding table (S150). The forwarding manager 200 also sets the masking value as the physical address of the corresponding best next hop entry of the best next hop table 440 (S150).

Referring to FIG. 5B, the forwarding manager 200 determines whether the network failure message is received from the network monitor 300 (S210). The forwarding manager 200 deletes the corresponding output interface number from the survival port list table 240 when the network failure message is received (S220).

The forwarding manager 200 retrieves the corresponding index number of the secondary next hop table 460 from the next hop list table 220 (S230). The forwarding manager 200 sets the physical address of the best next hop entry corresponding to the retrieved index number as the physical address of the corresponding secondary next hop entry of the secondary next hop table 460 (S240).

The forwarding manager 200 retrieves the set physical address corresponding to the index number from the forwarding table 420 and then retrieves the secondary next hop entry from the secondary next hop table 460 based on the retrieved physical address (S250). The forwarding manager 200 forwards the IP packets according to the retrieved secondary next hop entry (S260).

According to the present invention, the best route and the secondary route are set, so that the forwarding table is set using the information. When a network failure occurs in the corresponding interface, the network failure can be detected. Thus, until the best route is reset by the routing setter 100 and the forwarding table is reset, the IP packets are forwarded through the secondary route which is already set. Accordingly, loss of IP packets is significantly reduced, leading to high network reliability.

The present invention can also be realized as computer-executable instructions in computer_readable media. The computer_readable media includes all possible kinds of media in which computer_readable data is stored or included or can include any type of data that can be read by a computer or a processing unit. The computer_readable media include for example and not limited to storing media, such as magnetic storing media (e.g., ROMs, floppy disks, hard disk, and the like), optical reading media (e.g., CD_ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer_readable media can store and execute computer_readable codes that are distributed in computers connected via a network. The computer readable medium also includes cooperating or interconnected computer readable media that are in the processing system or are distributed among multiple processing systems that may be local or remote to the processing system. The present invention can include the computer-readable medium having stored thereon a data structure including a plurality of fields containing data representing the techniques of the present invention.

An example of a computer, but not limited to this example of the computer, that can read computer readable media that includes computer-executable instructions of the present invention includes a processor that controls the computer. The processor uses the system memory and a computer readable memory device that includes certain computer readable recording media. A system bus connects the processor to a network interface, modem or other interface that accommodates a connection to another computer or network such as the Internet. The system bus may also include an input and output interface that accommodates connection to a variety of other devices.

While the present invention has been described with reference to exemplary embodiments thereof, it will be understood by those skilled in the art that various changes in form and detail may be made therein without departing from the scope of the present invention as defined by the following claims.

What is claimed is:

1. A network routing control method, comprising:
setting best and secondary route information while receiving or transmitting a routing protocol control message with adjacent routers;
setting a table comprising best and secondary next hop entries using the best and secondary route information;
extracting a destination Internet protocol address from the best and secondary route information to set a forwarding table; and
when a failure occurs in a network which is set as the best next hop entry according to the best route information, setting the secondary next hop entry as an output interface according to the secondary route information and forwarding a corresponding packet.

2. The method of claim 1, further comprising:
registering an active output interface according to said table having the best and secondary next hop entries in a survival port list table,
wherein, in the step of forwarding the corresponding packet, an output interface experiencing the failure is deleted from the survival port list table.

3. The method of claim 2, further comprising:
storing an index number of said table having the best and secondary next hop entries in a next hop list table,
wherein, in the step of forwarding the corresponding packet, the packet is forwarded through the secondary next hop entry, between the best and secondary next hop entries having the same index number.

4. A network routing control method, comprising:
setting best and secondary route information while receiving or transmitting a routing protocol control message with adjacent routers;
setting best and secondary next hop tables using the best and secondary route information;
registering an active output interface according to said best and secondary next hop tables in a survival port list table;
storing an index of said best and secondary next hop tables in a next hop list table;
storing a destination Internet protocol address of the best and secondary route information in a forwarding table and setting a physical address of the best next hop entry of the best next hop table; and
when a failure occurs in a network which is set as the best next hop entry, setting the secondary next hop entry corresponding to the index as an output interface and forwarding a corresponding packet.

5. The method of claim 4, wherein the step of forwarding the corresponding packet includes deleting an output interface of the network experiencing the failure from the survival port list table.

6. The method of claim 5, wherein, in the step of forwarding the corresponding packet, the packet is forwarded through a secondary next hop entry, between the best and secondary next hop entries having the same index.

7. The method of claim 5, wherein the step of forwarding the corresponding packet further comprises:
after deleting the output interface of the network experiencing the failure from the survival port list table, retrieving an index of the secondary next hop table from the next hop list table;
setting a physical address of the best next hop entry corresponding to the retrieved index as a physical address of the secondary next hop entry of the secondary next hop table;
retrieving the set physical address from the forwarding table corresponding to the retrieved index; and
retrieving the secondary next hop entry from the secondary next hop table based on the retrieved physical address.

8. A network routing control apparatus, comprising:
a routing setter for setting best and secondary route information while receiving or transmitting a routing protocol control message with adjacent routers;
a forwarding manager for setting a table having best and secondary next hop entries using the best and secondary route information and extracting a destination Internet protocol address from the best and secondary route information to set a forwarding table; and
a forwarding portion for setting the secondary next hop entry as an output interface according to the secondary route information and forwarding a corresponding packet when a failure occurs in a network which is set as the best next hop entry according to the best route information.

9. The apparatus of claim 8, wherein said forwarding manager registers an active output interface according to the table having the best and secondary next hop entries in a survivable port list table, and deletes an output interface of the network experiencing the failure from the survival port list table.

10. The apparatus of claim 9, wherein the forwarding manager stores an index number of the table having the best and secondary next hop entries in a next hop list table and forwards the packet through the secondary next hop entry, between the best and secondary next hop entries having the same index number.

11. A network routing control apparatus, comprising:
a routing setter for setting best and secondary route information while receiving or transmitting a routing protocol control message with adjacent routers;
a forwarding manager for setting best and secondary next hop tables using the best and secondary route information, registering an active output interface according the best and secondary next hop tables in a survival port list table, storing an index number of the best and secondary next hop tables in a next hop list table, storing a destination Internet protocol address of the best and secondary route information in a forwarding table, and setting a physical address of a corresponding best next hop entry of the best next hop table; and
a forwarding portion for setting the secondary next hop entry corresponding to the index number as an output interface to forward a corresponding packet when a failure occurs in a network which is set as the best next hop entry.

12. The apparatus of claim 11, wherein said forwarding manager deletes an output interface of the network experiencing the failure from the survival port list table.

13. The apparatus of claim 12, wherein said forwarding manager forwards the packet through the secondary next hop entry, between the best and secondary next hop entries including the same index number.

14. The apparatus of claim 13, wherein said forwarding manager retrieves an index number of the secondary next hop table from the next hop list table after deleting the output interface of the network experiencing the failure from the survival port list table, and sets a physical address of the best next hop entry as a physical address of a secondary next hop entry of the secondary next hop table corresponding to the retrieved index number.

15. The apparatus of claim 14, wherein said forwarding manager retrieves the set physical address from the forwarding table corresponding to the retrieved index number, and retrieves the secondary next hop entry from the secondary next hop table based on the retrieved physical address.

16. A network routing control apparatus, comprising:
a routing setter sets a best route being the lowest in cost from among a plurality of routes and a secondary route which is the next lowest in cost by routing protocol control message which is received and transmitted from and to the adjacent routers;
a forwarding manager managing a list of output interfaces in an active state among a plurality of output ports of a first router in a network system connected to a second router, said forwarding manager manages the active output interface list using a survival port list table, the survival port list table maintains the active output interface list information when an interface is produced in said second router;
a forwarding portion retrieves the destination Internet Protocol address with reference to a forwarding table and the physical address of a best next hop table which is already set when the Internet Protocol packet is received, said forwarding portion retrieves a best next route entry, from the best next hop table, corresponding to the physical address retrieved from the forwarding table, said forwarding portion adds a header to the Internet protocol packet using the retrieved next hop entry value and forwards the Internet protocol packet to a corresponding router; and
a network monitor detects whether a network set by the best route information fails and then outputs the detection result to the forwarding manager.

17. The apparatus of claim 16, wherein said forwarding manager checks whether output interfaces for outputting a corresponding Internet protocol packet according to routes set by the best route information and the secondary route information provided from said routing setter are in an active state, using the survival port list table, when the output ports are in an active state, said forwarding manager extracts next hop information from the best route information to set a best next hop table, and extracts next hop information from the secondary route information to set a secondary next hop table.

18. The apparatus of claim 16, wherein said forwarding manager extracts destination Internet protocol address information from the best route information provided from the routing setter to set the forwarding table.

19. The apparatus of claim 16, said forwarding manager extracts a marking value of the destination Internet protocol address and the netmask from the best route information provided from the routing setter to set the forwarding table, said forwarding manager sets the marking value as a physical address value of a corresponding entry of the best next hop table, said forwarding manager stores a list of indexes of the best and secondary next hop tables for corresponding interface numbers in the next hop list table.

20. The apparatus of claim 16, wherein said forwarding portion retrieves the destination Internet protocol address of the input Internet protocol packet from the forwarding table, and retrieves the physical address of the secondary next hop table which is already set for the retrieved destination Internet protocol address, said forwarding portion retrieves a secondary next route entry, from the secondary next hop table, corresponding to the physical address retrieved from the forwarding table, said forwarding portion adds a header to the IP packet using the retrieved secondary next hop entry value and forwards it to the corresponding router.
